(19) United States
(12) Patent Application Publication
(10) Pub. No.: US 2002/0077792 A1
(43) Pub. Date: Jun. 20, 2002

(54) Early warning in e-service management systems

(75) Inventor: Shi-Yue Qiu, Ellicott City, MD (US)

Correspondence Address: PILLSBURY WINTHROP LLP, 1600 TYSONS BOULEVARD, MCLEAN, VA, 22102, US

(73) Assignee: PANACYA, INC., ANNAPOLIS JUNCTION, MD (US)

(21) Appl. No.: 09/902,094

(22) Filed: Jul. 11, 2001

Related U.S. Application Data
(60) Provisional application No. 60/243,472, filed on Oct. 27, 2000.
(60) Provisional application No. 60/243,401, filed on Oct. 27, 2000.
(60) Provisional application No. 60/243,469, filed on Oct. 27, 2000.
(60) Provisional application No. 60/243,397, filed on Oct. 27, 2000.
(60) Provisional application No. 60/243,470, filed on Oct. 27, 2000.

(51) Int. Cl. G06F 17/10

(52) U.S. Cl. 703/2

(57) ABSTRACT

An arrangement is provided for generating early warning of threshold violations in e-service management systems. The behavior of a variable is modeled statistically based on a plurality of data values of a variable collected over a period of time. The modeling generates a behavior model for the variable, represented by a set of model parameters. An early warning for a threshold violation of the variable with respect to a threshold is generated based on the behavior model and a plurality of data values of the variable collected online. The abnormal behavior of the variable is detected or forecasted according to online data values of the variable and the early warning generated.

### 1. APPLICATION DATA

The present invention is related to five provisional patent applications: U.S. patent application Ser. No. 60/243,472, titled “The eService Business Model”, U.S. application Ser. No. 60/243,401, titled “Framework for eService Management”, U.S. patent application Ser. No. 60/243,469, titled “Behavior Experts in eSeivice Management”, U.S. application Ser. No. 60/243,397, titled “The Uniform Data Model”, and U.S. application Ser. No. 60/243,470, titled “Adaptive Feedback Control in eService Management”. The present invention as well as the five provisional patent applications relate to various aspects of eService management. The subject matter of each is hereby incorporated by reference into each of the others.

### 2. RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

3. Field of the Invention

Aspects of the present invention relate to the field of e-commerce. Other aspects of the present invention relate to a method and system to intelligently manage an infrastructure that supports an e-service business.

4. General Background and Related Art

The expanding use of the World-Wide Web (WWW) for business continues to accelerate and virtual corporations are becoming more commonplace. Many new businesses, born in this Internet Age, do not employ traditional concepts of physical site location (bricks and mortar), on-hand inventories and direct customer contact. Many traditional businesses, that want to survive the Internet revolution are rapidly reorganizing (or re-inventing) themselves into web-centric enterprises. In today's high-speed Business-to-Business (B2B) and Business-to-Customer (B2C) eBusiness environment, a business entity must provide high quality service, scale to accommodate exploding demand and be flexible enough to rapidly respond to market changes.

The growth of eBusiness is being driven by fundamental economic changes. Firms that harness the Internet as the backbone of their business are enjoying tremendous market share gains—mostly at the expense of the unenlightened that remain true to yesterday's business models. Whether it is rapid expansion into new markets, driving down cost structures, or beating competitors to market, there are fundamental advantages to eBusiness that cannot be replicated in the “brick and mortar” world.

This fundamental economic shift, driven by the tremendous opportunity to capture new markets and expand existing market share, is not without great risks. If a customer cannot buy goods and services quickly, cleanly, and confidently from one supplier, a simple search will divulge a host of other companies providing the same goods and services. Competition is always a click away.

eBusinesses are rapidly stretching their enterprises across the globe, connecting new products to new marketplaces and new ways of doing business. These emerging eMarketplaces fuse suppliers, partners and consumers as well as infrastructure and application outsourcers into a powerful but often intangible Virtual Enterprise. The infrastructure supporting the new breed of virtual corporations has become exponentially more complex—and, in ways unforeseen just a short while ago, unmanageable by even the most advanced of today's tools. The dynamic and shifting nature of complex business relationships and dependencies is not only particularly difficult to understand (and, hence manage) but even a partial outage among just a handful of dependencies can be catastrophic to an eBusiness' survival.

Businesses are racing to deploy Internet enabled services in order to gain competitive advantage and realize the many benefits of eBusiness. For an eBusiness, time-to-value is so critical that often these business services are brought online without the ability to manage or sustain the service. eBusinesses have been ravaged with catastrophe after catastrophe. Adequate technology, to effectively prevent these catastrophes, does not exist.

eBusiness infrastructures operate around the clock, around the globe, and constantly evolving. If a critical supplier in Asia cannot process an electronic order due to infrastructure problems, the entire supply chain comes to a grinding halt. Who understands the relationships between technology and business processes and between producer and supplier? Are they available 24 hours/day, 7 days/week, and 365 days/year? How long will it take to find the right person and rectify the problem? The promise of B2B, B2C and eCommerce in general will not be fully realized until technology is viewed in light of business process to solve these problems.

Web-enabled eBusiness processes effectively distill all computing resources down to a single customer-visible service (or eService). For example, a user interacts with a web site to make an online purchase. All of the back-end hardware and software components supporting this service are hidden, so the user's perception of the entire organization is based on this single point of interaction. How can organizations mitigate these risks and gain the benefits of well-managed eServices?

Never before has an organization been so dependent on a single point of service delivery—the eService. An organization's reputation and brand depend on the quality of eService delivery because, to the outside world, the eService is the organization. If service delivery is unreliable, the organization is perceived as unreliable. If the eService is slow or unresponsive, the company is perceived as being slow or unresponsive. If the Service is down, the organization might as well be out of business.

Further complicating matters, more and more corporations are outsourcing all or part of their web-based business portals. While reducing capital and personnel costs and increasing scalability and flexibility, this makes Application Service Providers (ASPs), Internet Service Providers (ISPs) and Managed Service Providers (MSPs) the custodians of a corporation's business. These “xSPs” face similar challenges—delivering quality service in a rapid, cost efficient manner with the added complication of doing so across a broad array of clients. Their ability to meet Service Level Agreements (SLAs) is crucial to the eBusiness developing a respected, high quality electronic brand—the equivalent of prime storefront property in a traditional brick and mortar business.

The Internet enables companies to outsource those areas in which the company does not specialize. This collaboration strategy creates a loss of control over infrastructure and business processes between companies comprising the complete value chain. Partners, including suppliers and service providers must work in concert to provide a high quality service. But how does a company control infrastructure which it doesn't own and processes that transcend its' organizational boundaries? Even infrastructure outsourcers don't have mature tools or the capability to manage across organizational boundaries.

The underlying problem is not lack of resources, but the misguided attempt to apply yesterday's management technology to today's eService problem. As noted by Forrester Research, “Most companies use ‘systems’ management tools to solve pressing operational problems. None of these tools can directly map a system or service failure to business impact.” To compensate, they rely on slow, manual deployment by expensive and hard-to-find technical personnel to diagnose the impact of infrastructure failures on service delivery (or, conversely, to explain service failures in terms of events in the underlying infrastructure). The result is very long time-to-value and an unresponsive support infrastructure. In an extremely competitive marketplace, the resulting service degradation and excessive costs can be fatal.

### BRIEF DESCRIPTION OF THE DRAWINGS

The present invention is further described in terms of exemplary embodiments which will be described in detail with reference to the drawings. These embodiments are non-limiting exemplary embodiments, in which like reference numerals represent similar parts throughout the several views of the drawings, and wherein:

FIG. 1 shows a high-level block diagram of an eService management system;

FIG. 2 shows expanded block diagrams of both local service management systems and the global eService management system and their interactions via a dispatcher;

FIG. 3 shows the input and output relationship of a Behavior eXpert (BeX);

FIG. 4 shows different functional modes of a BeX;

FIG. 5 illustrates an exemplary internal structure of a BeX in relation to other parts in a local service management system;

FIG. 6 shows a time series variable values with an underlying pattern;

FIG. 7 shows an exemplary variable behavior that can be described by two embedded patterns;

FIG. 8 depicts the internal structure of the statistical learning mechanism of a BeX;

FIG. 9 is an exemplary flowchart of a process, in which statistical models characterizing the normal and dynamic behavior of a variable are established and are applied in generating early warning of threshold violation in eService management;

FIG. 10 is an exemplary flowchart for online normal behavior modeling;

FIG. 11 illustrates the actual behavior of a time series variable and its violation of a threshold;

FIG. 12 illustrates the predicted behavior of a time series variable; and

FIG. 13 is an exemplary flowchart for an early warning mechanism.

### DETAILED DESCRIPTION

An embodiment of the present invention is illustrated that is related to Behavior eXperts (BeXs) employed in an eService management system. The present invention enables intelligent eService management by incorporating statistical behavior modeling and abnormal behavior forecasting (or early warning) capabilities in a BeX.

A Behavior Expert (BeX) in an eService management system is a distributed, autonomous intelligent agent, designed to detect, analyze, predict, and control certain behavior of the components of a business infrastructure that supports the underlying eService. A BeX may be attached to a component (or an application) of an eBusiness infrastructure so that the operational status or the behavior of the component may be dynamically monitored and adaptively adjusted to optimize the eService quality.

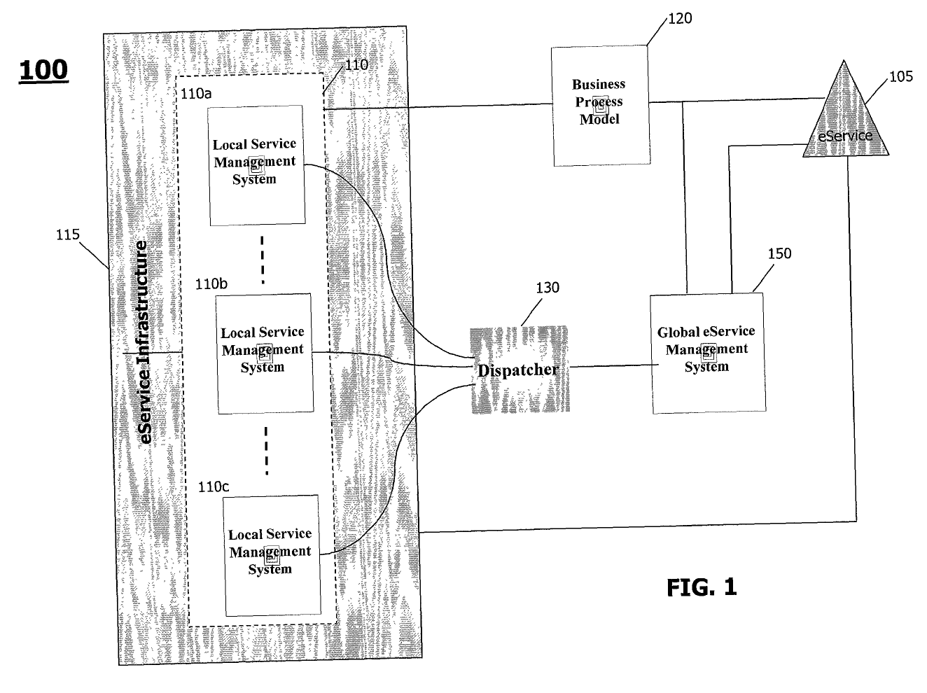

FIG. 1 is a high level diagram of an eService Management System 100. An eService 105 is a web-centric service, which allows electronic transactions over the Internet. Such a web-centric service may, for example, sell books, shoes, or flowers. It may also sell stocks or information. The eService 105 is supported by an eService infrastructure 115, which may comprise infrastructure components such as web servers, databases, billing systems, or other eServices. In the eService infrastructure 115, each component may play a distinct role. For example, for a shoes.com eService that sells shoes, a database may be part of the infrastructure that supports shoes.com service and the database may store all the transaction information. The performance of each infrastructure component may affect the overall quality of service of shoes.com eService.

In FIG. 1, there is a cluster, 110, of local service management systems. Each of the local service management systems may be responsible for the management of a local system which is part of the eService infrastructure 115. For example, local service management system 110b may be responsible for managing a database for an eService called shoes.com. A local system may comprise one or more infrastructure components. The performance information about infrastructure components or a local system of the eService infrastructure 115 may be sent, via a dispatcher 130, to a global data repository (not shown), located in a global eService management system 150. The information stored in the global data repository may be accessed and integrated by the global eService management system 150 to assess the overall performance of the eService infrastructure 115 and subsequently to estimate the overall service quality of the eService 105. In FIG. 1, the dispatcher 130 may represent a collective comprising one or more distributed dispatchers.

The quality of an eService depends on various factors. Such factors are related to both the performance of individual infrastructure components and how the business process of the eService takes place within the supporting eService infrastructure. Different components in the eService infrastructure 115 may impact the quality of eService differently, depending on the role of each component with respect to the business process of the eService. Therefore, the strategy to manage the infrastructure that supports an eService may be directly related to or dictated by the business process model of the eService.

In FIG. 1, business process model 120 is derived from the eService 105. The business process model 120 dictates both how the eService infrastructure 115 should be managed by local service management systems 110 and how the global eService management system 150 integrates the information from systems 110 to evaluate the overall performance of the eService infrastructure 115. The knowledge about the business process model 120 may be distributed in local service management systems 110a, 110b, . . . , 110c.

There may be multiple global eService management systems. Different global eService management systems may be responsible for different eServices but they may share local service management systems. Therefore, while the global eService management system 150 may seem to be a centralized unit in FIG. 1, it may be distributed, similar to local service management systems.

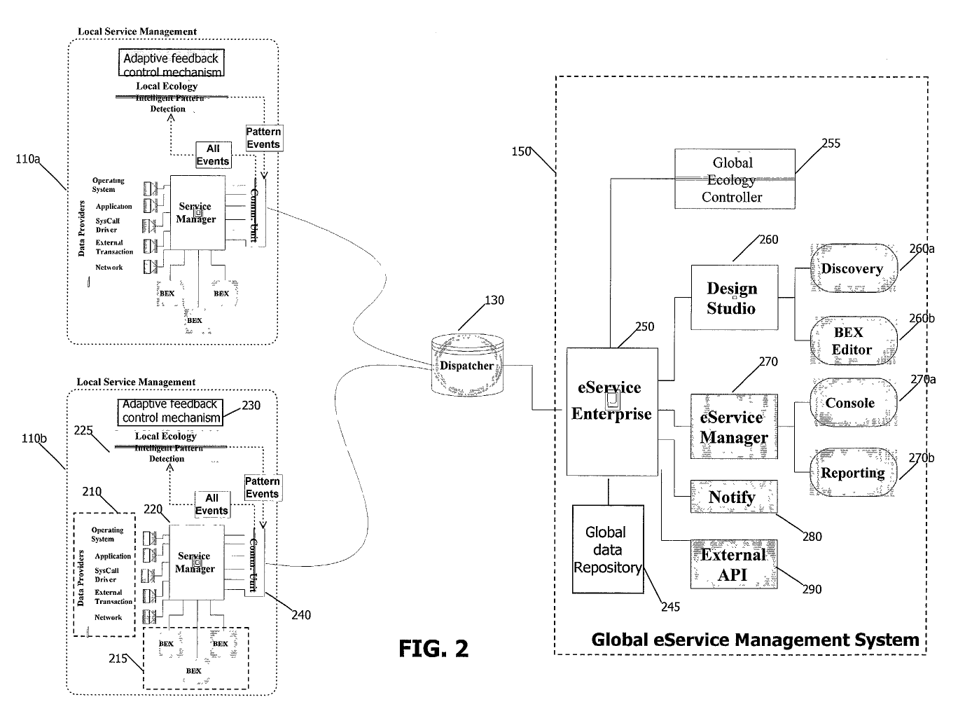

FIG. 2 presents the exemplary internal structures of both a local service management systems (110b) and the global eService management system 150 and how they interact with each other. In FIG. 2, local service management system 110b comprises a plurality of data providers 210, a service manager 220, one or more Behavior eXperts (BeXs) 215, a local ecology pattern detector 225, an adaptive feedback control mechanism 230, and a communication unit 240.

Data providers 210 supply observation data (observations in terms of, for example, the operational status), acquired from various infrastructure components, to the service manager 220. The service manager 220 converts the observation data to Generic Data Objects so that different Behavior eXperts (BeXs) 215 may access the observation data in a uniform way.

Each BeX in a local service management system may be designated to monitor an infrastructure component. A BeX at component level may access the observation data acquired (by the data providers) from the underlying infrastructure component and analyze the behavior of the infrastructure component based on the observation data. A BeX may post some detected abnormal behavior of individual components, in the form, for example, states or events, on a blackboard server (not shown in FIG. 2) located in the service manager 220. Such posted information may be shared among different BeXs and accessed by the local ecology pattern detector 225.

The local ecology pattern detector 225 may retrieve information from the blackboard server so that abnormal behavior occurred in different infrastructure components may be reviewed as a whole in order to detect any alarming trend or ecological pattern of the underlying local system. Detected ecological patterns may be reported, in the form of, for example, events together with some of the abnormal events at component level that have high priorities, to the dispatcher 130, via the communication unit 240.

Each local service management system (110a, . . . , 110b, . . . 110c) may act asynchronously to monitor the performance of a local infrastructure. Internal to each local management system (110a, . . . , 110b, . . . 110c), an adaptive feedback control mechanism 230 may be activated so that the behavior of a local service management system may be adaptively tuned towards some desired behavior. For example, if a BeX in a local service management system (110b) always reports a certain type of abnormal event and it always turned out to be a false alarm (e.g., the reported event does not have a significant ecological impact on the local system), the local service management system 110b may trigger the adaptive feedback control mechanism 230 to tune the responsible BeX so that the BeX becomes less sensitive to these events and, consequently, to become more aware of the events that actually do not impact the eService.

The performance information gathered from different local service management systems may be routed, through the dispatcher 130, to the global eService management system 150. The global eService management system 150 comprises a global ecology controller 255, an eService enterprise 250, a design studio 260, a eService manager 270, a notifier 280, and a port 290 for external APIs.

Data routed from the dispatcher 130 may be stored in the global data repository 245 and accessed by the global ecology controller 255. The global ecology controller 255 may then integrate the information from local service management systems 110 to and evaluate the performance of the overall eService infrastructure. The global ecology controller 255 may also estimate the service quality of the eService 105 based on the assessment about the overall infrastructure performance. This may be done by measuring the impact of detected abnormal behavior in different parts of the infrastructure on the eService. The translation from local infrastructure performance data to overall eService quality may be performed based on the business process model of the underlying eService.

The global ecology controller 255 may also activate an adaptive feedback control. It may send feedback adjustments to different local service management systems, from where the adjustments may be passed further down to various individual BeXs. The purpose of activating an adaptive feedback control may be to tune the behavior of an eService management system so that it converges to an optimal state to ensure the quality of an eService.

In FIG. 2, both the local ecology pattern detectors 225 as well as the global ecology controller 255 may be realized using BeXs. Essentially, a BeX is an intelligent reasoning mechanism that takes input data and generates inference output based on its expert knowledge. The distinction between a BeX at component level and a BeX for, for example, realizing a local ecology pattern detector, may be merely functional rather than structural and methodological. A BeX that is attached to an infrastructure component may perform an individual monitoring task. A BeX implemented at an ecological level may perform higher level integration task.

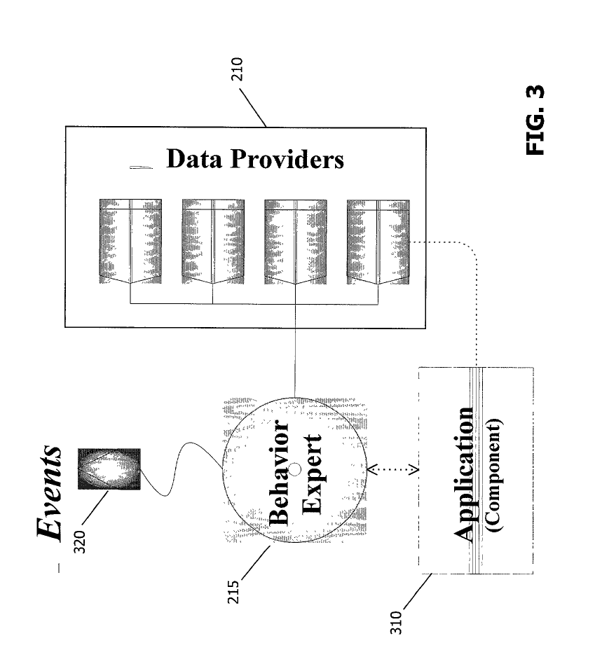

FIG. 3 depicts the input and output relationship of a BeX. A BeX 215 may be associated with one or more infrastructure components 310. Data providers 210 acquire performance data from the associated infrastructure components 310 and supply observation data to the BeX 215. To detect abnormal behavior in the associated components, the BeX may base its analysis on the observation data supplied by the data providers 210. When abnormal behavior is detected, the BeX throws one or more events 320 to signal the abnormal behavior of the underlying components 310. Events thrown by other BeXs may also be made available by the data providers 210 as the observation data. In this way, different BeXs may interact with each other, sharing what is detected and making further inferences.

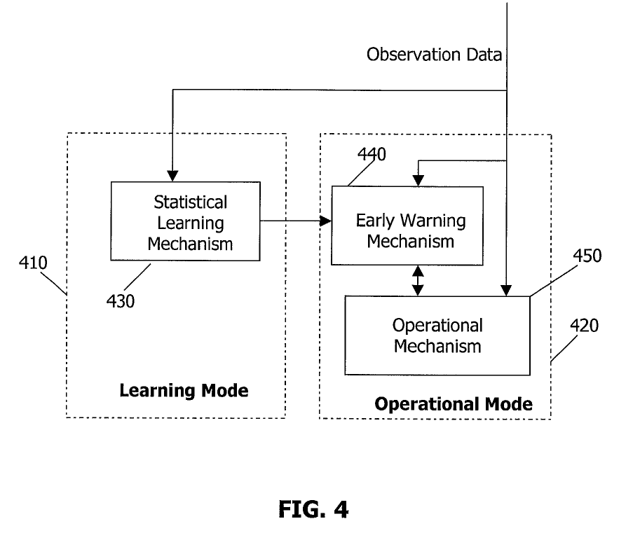

FIG. 4 illustrates that a BeX may function in different modes: learning mode 410 and operational mode 420. In FIG. 4, the observation data is fed to a BeX and may be utilized during both the learning mode 410 and the operational model 420. During the learning mode 410, the BeX learns the patterns of variables or ordinary behavior of the variables under normal operation environment of the system. Such learning may be achieved using different methods. In the exemplary construct of a BeX shown in FIG. 4, a statistical learning mechanism 430 is used to accomplish the task. The learned behavior may be captured in a behavior model of the variable. Such a model may be an linear or non-linear model.

In the operational mode, a BeX monitors its associated component(s) and detects any abnormal behavior. Abnormal behavior may be defined a priori or it may be detected by comparing with learned normal behavior. Detection of abnormal behavior of an infrastructure component may be achieved by an operational mechanism 450 within a BeX. The operational mechanism 450 monitors the operational status of its associated component through the observation data and determines whether the operational status is acceptable according to some criteria. For example, a BeX that monitors a database may detect an abnormal behavior when the database is not responding to queries, given that the acceptable behavior of the database is that its responding time to a query should be less than 20 seconds. In this case, the BeX reports the abnormal behavior after detecting that the normal responding time has elapsed.

The variable behavior learned during the learning mode 410 may be applied during the operational mode to proactively predict any incoming abnormal behavior before it occurs. In FIG. 4, such proactive prediction is achieved by an early warning mechanism 440. Based on the learned variable behavior from the statistical learning mechanism 430 and the observation data (that reflect the current behavior of the underlying component), the early warning mechanism 440 estimates, with some certainty (may be expressed in the form of a probability), when, in the future, an abnormal behavior will occur. Such early warning may be sent to the operational mechanism 450 which will react accordingly to either report the estimated trend or incorporate the warning into its own inference.

The learning mode 410 and the operational mode 420 may be running at different times or simultaneously. Particularly, during the learning mode 410, there may be different states of learning. For example, a BeX may learn some variable behavior offline from some historical data in a batch mode or the BeX may learn dynamic variable behavior online during its operation in an incremental fashion. The former may be applied before the BeX is first deployed and the latter may be applied after the BeX is up and running.

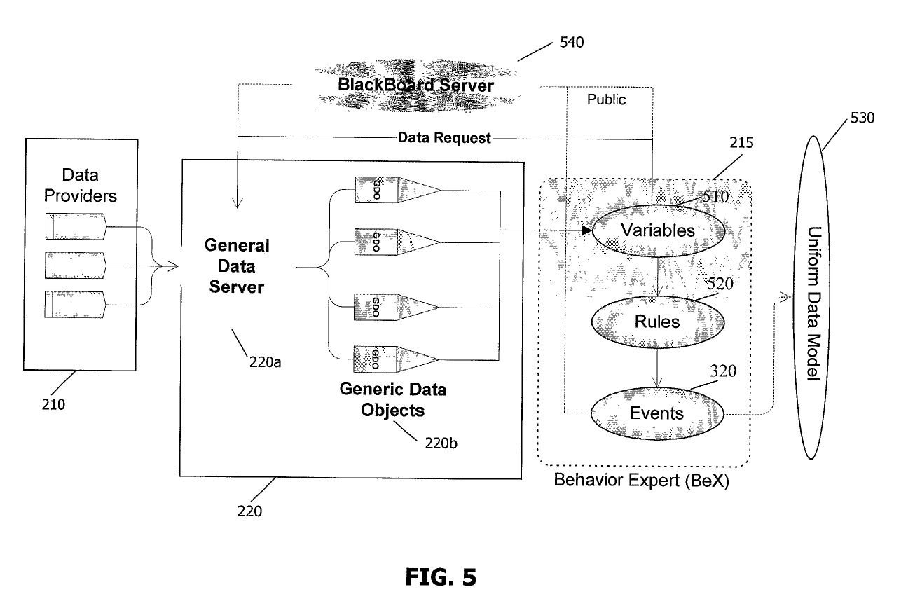

In the operational mode, the designated tasks of a BeX are dictated through a set of variables and rules and the reaction of the BeX to the operational status of its underlying component is defined through a set of events. This is illustrated in FIG. 5. In FIG. 5, a BeX 215 operates based on variables 510, rules 520, and events 320. Rules 520 govern the transitional relationship between the variables 510 and events 320. Events 320 may be generated based on updated states which may be set based on the values of the variable 510. Rules 520 may be classified into metric rules and behavior rules, where the metric rules govern the transition between variables and states and behavior rules govern the transition between states and events.

Observation data acquired by the data providers 210 is sent to a general data server 220a where the observation data is converted into Generic Data Objects (GDO) 220b so that heterogeneous kinds of data may be packaged and accessed in a uniformed way.

A BeX (e.g., 215) may access the GDOs 220b to instantiate or to populate its internal variables 510. The updated variable values may trigger or fire rules 520. Fired rules may then generate certain events 320 (indicating abnormal behavior of the infrastructure components that are monitored by BeX 215), which are formatted in accordance with the UDM 530 before being posted on the blackboard server 540.

A rule may define some violation of acceptable behavior and may take the form:

name. IF premise THEN then-action ELSE else-action;

wherein “name” is the identifier of a particular rule, “IF premise” describes a condition, “then-action” describes the action to be taken when the condition satisfies, and “else-action” describes the action to be taken when the condition does not satisfy. The condition described in the “IF premise” may specify violation of acceptable behavior in terms of a variable value exceeds some expected value or threshold. For example, “IF Memory Capacity <20%” describes that when the value of variable Memory Capacity is below a threshold of 20%” (a threshold that may define that the acceptable behavior of a memory is that it has more than 20% of its memory available), a violation of a threshold occurs. The rules may be designed to enforce some performance requirements, imposed on the running components of an eService infrastructure to support an underlying eService.

Detecting abnormal behavior usually involve comparing variable values to some thresholds. Since the underlying infrastructure component that is monitored may operate continuously, the variable values may need to be sampled regularly according to some internal clock (which also regulates how often the BeX detects abnormal behavior in its operational mode). Such regular data sampling produces time series variables, each of which may present some particular pattern over time. The statistical learning mechanism 410 is designed to learn such patterns based on time series variable values.

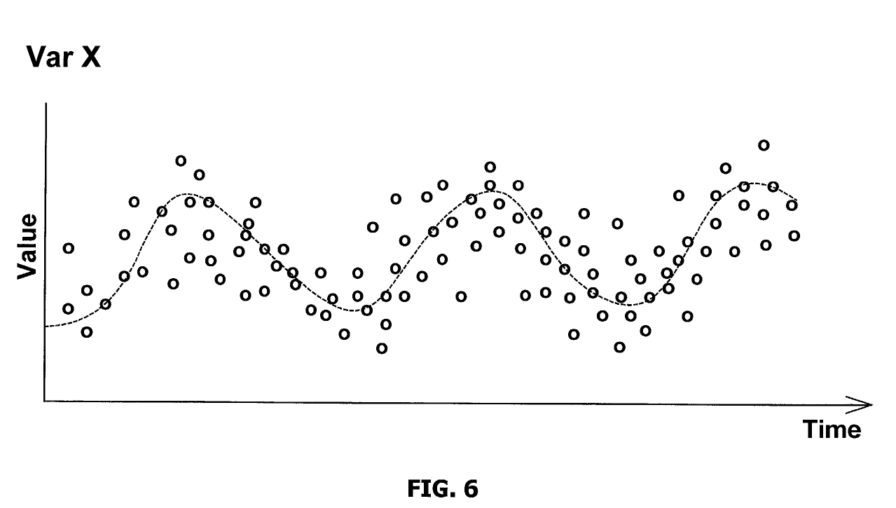

Various mathematical and statistical techniques are available for discovering sets of repeating patterns from collections of data. Using statistical learning, both short term and long term harmonic patterns in data and, knowing the regularity of the pattern (within error tolerances) can be used to predict the behavior at some future time. When a BeX is in its learning mode, it may continuously collect data from the associated data providers for several periods and performs statistical analysis to discover any emerging patterns in the data. FIG. 6 illustrates an example in which the time series values of a variable X form an emerging pattern over time. In FIG. 6, the horizontal axis represents time, vertical axis represents the magnitude of variable values, the dots represent the discrete values of a variable X recorded over time, and the curve is a sine-wave like pattern representing the emerging patter of variable X in time.

Data points recorded over time often include noise or outliers that are usually extraneous data points that do not fit into the principle pattern of the data. In detecting an emerging pattern based on recorded data points, such noise may have to be considered in the modeling process by either modeling the noise simultaneously or reducing the brittleness of the data prior to the modeling. By removing noise, the emerging patter or the actual trend line over the analysis time horizon may be more reliably discovered. This discovery may take the form of a non-linear model to capture the variable's behavior.

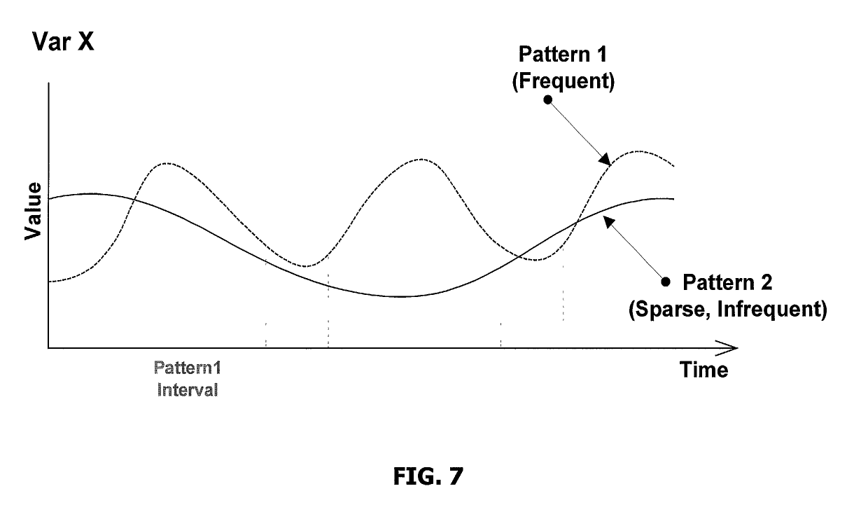

Time series variables may have different underlying intrinsic patterns of varying amplitudes and wavelengths. A data stream containing only one or two patterns is called shallow data while data streams that have many patterns is called deep data. FIG. 7 illustrates a data stream that may be represented by two different underlying patterns embedded in the value of variable X. In FIG. 7, the first pattern, pattern 1, presents a high frequency and the second patter, pattern 2, presents a lower frequency. They are modulated on top of each other and together they form the underlying pattern of the variable X over time.

A statistical learning model may be designed to identify and to quantify any number of such intrinsic patterns, although long term patterns with low amplitudes may be much more difficult to detect since they are generally obscured by random noises. Data series containing multiple patterns also introduce a higher level of noise (seen as apparent randomness or excessive outliers) into the modeling process simply by virtue of the patterns themselves. The modeling technique used to learn the behavior of variables that are characterized by multiple patterns may have to be designed accordingly to deal explicitly with problems associated with multiple and embedded patterns.

The validity of a model and hence its predictive capabilities is fundamentally determined, all other factors being equal, by its access to historical data. For example, if inter-day behavior is needed, several days of data collection is necessary. However, if day-to-day variation pattern analysis within a week is also needed, several weeks of data collection is required. The amount of data required is proportional to both the longitudinal scope of the underling pattern and the necessary precision of the model itself.

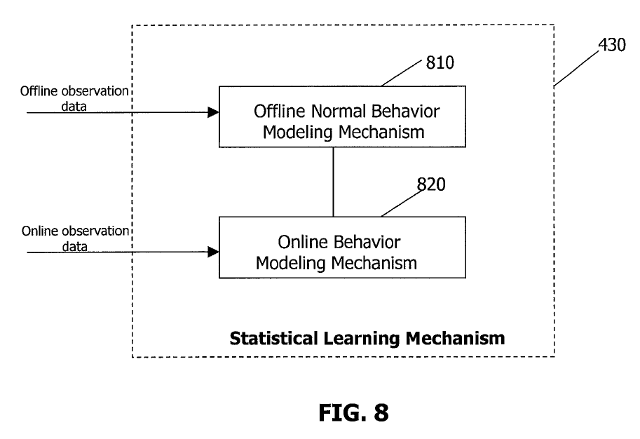

FIG. 8 depicts an exemplary construct of the statistical learning mechanism 430, which comprises two parts: an offline normal behavior modeling mechanism 810 and an online behavior modeling mechanism 820. The offline normal behavior modeling mechanism 810 learns a variable's normal pattern in a batch mode based on offline observation data corresponding to pre-recorded data points. What it captures is the static or regular pattern of the underlying variable without considering the dynamic noise factor. For example, a sine wave is a regular pattern that can be characterized using a sine function.

The online behavior modeling mechanism 820 learns the dynamics of a variable's behavior based on online observation data corresponding to the data points collected during a BeX's operations. What it captures is the dynamic or adaptive pattern of the underlying variable, which is modulated on top of the regular pattern, learned during the offline modeling. For example, if a variable has, under normal situations, a sine pattern, its values measured online usually will not exactly fit the sine wave. This may be due to noise. To model a variable's pattern, both its regular and its dynamic patterns need to be captured. The online behavior modeling mechanism 820 is designed to characterize the variable's dynamics in time.

Using what is learned by both the offline normal behavior modeling mechanism 810 and the online behavior modeling mechanism 820, a compound statistical model for a variable may be built that is capable of characterizing the real time behavior of a variable.

The variable patterns that a BeX learns offline are the ordinary behaviors as seen under the (assumed) normal operation of the system. These behaviors may be encoded in a non-linear time series model. This model is deployed when the BeX is running in operational mode to regularly forecast near-term future values of the variable. This forecast constitutes the root mechanism in the early warning mechanism 440.

In general, a variable has a time-varying or non-stationary behavior. The models discussed below describe the time-varying behavior at different detail levels. If a time-varying variable is expected to fluctuate around a mean value, then the following simple model may be sufficient,

Sₗ=μ+yₗ, (1)

where Si is the measured value at time index i, μ is the mean of the variable obtained through Least Squares Regression (LSR), assuming uniform time interval, as:

$$μ = \frac{{\sum }_{i} {S}_{i}}{{\sum }_{i} 1} , \qquad ( 2 )$$

and residual yₗ is a random variable with a mean of zero. This is a mean plus standard deviation model describing the time-varying data fluctuating around a mean value.

If a time-varying variable has a pattern within a given period (such as a day) but the variation between the periods (as an example, day-to-day variation) is assumed to be random, then the following model may sufficiently describe the pattern,

Sₜₗ=μ+αₗ+yₜₗ,

where i is the index for the time-of-day, l is the index for the l-th day in the data collected, and α denotes the i-th time-of-day deviation from the overall mean μ. The factor αᵢ is obtained from the LSR as

$${α}_{i} = \frac{{\sum }_{l} {S}_{il}}{{\sum }_{l} 1} - μ , \qquad ( 4 )$$

and the overall mean is calculated through LSR as

$$μ = \frac{{\sum }_{il} {S}_{il}}{{\sum }_{il} 1} \qquad ( 5 )$$

With the above definitions, the residual can be computed as: yₜₗ=Sₜₗ−μ−αₗ. A residual is the part of the model attributed to random fluctuations or noise in the pattern associated with the same point.

If a time-varying variable has a pattern not only within a period (e.g., the intra-day patterns) but also between the periods (e.g., day-to-day within a week—such as data that has a typical variation from Monday to Friday, on top of the variation within a day), then the following model may sufficiently describe the pattern, assuming the week-to-week variation is random,

S_{yl}=μ+αₜ+βⱼ+y_{yl},

where j is the index for the day-of-week, l is the index for the l-th week in the data collected, and β denotes the j-th day-of-week deviation from the overall mean, computed as

$${β}_{j} = \frac{{\sum }_{il} {S}_{ijl}}{{\sum }_{il} 1} - μ \qquad ( 7 )$$

and the time-of-day pattern and overall mean are calculated through LSR as

$$\begin{matrix}{α}_{i} = \frac{{\sum }_{jl} {S}_{ijl}}{{\sum }_{jl} 1} - μ & ( 8 ) \\ μ = \frac{{\sum }_{ijl} {S}_{ijl}}{{\sum }_{ijl} 1} & ( 9 )\end{matrix}$$

The residual may then be computed as: yₜⱼₗ=Sᵢⱼₗ−μ−α₁−βⱼ

Such modeling may be easily extended to larger time periods. For example, it may be extended to week-of-month effects. In this case, an additional parameter may be used to characterize the k-th week-of-month deviation, denoted by γₖ. This may be necessary for some data that has a structured variation from the first week to the last week of the month, on top the time-of-day and day-of-week variation, assuming the month-to-month variation is random.

Different models described above use indices i, j, k, l, that correspond to time. That implies that given any time reference point t, when a variable is measured, the time reference point t may need to be translated into the corresponding indices, i, j, k, l, depending on the specific model used. Using the time reference, the random variables (representing residuals) yₗ, yₜₗ, yₜⱼₗ, may be uniformly denoted by yₜ.

As stated earlier, the offline normal behavior modeling mechanism 810 is used to learn the static and regular behavior of a variable. To derive a model that characterize only the regular behavior of a variable based on measured data points (which embed noise), a noise factor may need to be identified and removed from the data points. In addition, an autocorrelation relationship may exist among adjacent data points. That is, yₜ may not be an independent and identical distributed (i.i.d) random variable. This property of yₜ may further complicate the model. The following model may be applied to remove possible autocorrelation in yₜ.

yₗ+αₗyₜ₋ₗ+. . . +αₚyₜ₋ₚ=σ×μₜ,

The above equation captures the dependency between yₜ and the same residuals measured at p previous time reference points. The equation 10 characterizes the p-order autoregressive (AR) process. Let â^{T}={1,α₁, α₂, . . . , αₚ} be the (p+1)-dimensional AR parameter vector, and μₜ is an uncorrelated normal distributed random variable with zero mean and variance of 1 (white noise), and σ is the standard deviation. Let â^{T}={α₁, α₂, . . . αₚ} be a p-dimensional vector derived from α^{T} by deleting its first element; then the covariance estimates of α and the corresponding σ can be calculated by

\hat{α}=−D⁻¹\hat{d} (11)

σ²=â^{T}Câ

Here D is a p×p submatrix of C obtained by deleting row and column zeros and \hat{d} is the p-dimensional vector identical to the first column of C with the zeroth element deleted. The covariance matrix elements are defined as

$${c}_{ij} = \frac{1}{{N}^{′}} {\sum }_{t = p + 1}^{N} {y}_{t - 1} {y}_{t - j} \qquad ( 13 )$$

where N is the number of measured points in yₜ and N′=N−p.

According to the description above, the offline normal behavior modeling mechanism 810 establishes an offline normal behavior model for a variable by estimating the model parameters μ, α₁, βⱼ, γₖ, {α₁, . . . , αₚ}, σ based on given measured data points. During offline learning, the learning process may be performed in a batch mode using the data points recorded prior to the learning. The learned model, represented by those model parameters, is deployed when the underlying BeX is put in its operational mode.

Since the offline normal behavior model does not address (intentionally removes) the dynamics of the variable behavior, the online behavior modeling mechanism 820 may be used to characterize the dynamic behavior of a variable. An online statistical learning mechanism may learn through some window period sliding along the time and may characterize the dynamics using some statistics computed from such sliding windows. The statistics computed from such sliding windows is then compared with the reference window to detect any slow and sudden statistical change in the time series variable. For example, such statistics may include averages or standard deviations.

To characterize such dynamic behavior into patterns, it may also be necessary for an online statistical learning mechanism to detect different segments along time in which the statistical properties of the variable dynamics differ significantly. There are known approaches to perform such segmentation based on statistical properties. For example, Generalized Likelihood Ratio (GLR) segmentation does this. When a different segment is identified, the statistics accumulated in the previous segment may need to be replaced with the new statistics accumulated for the new segment. In this way, the online behavior modeling mechanism 820 adaptively, from segment to segment, characterizes the dynamic behavior of a time series variable.

Given a normal behavior model for a variable (learned by the offline behavior modeling mechanism 810), the dynamics of the variable behavior can be captured in the residual yₜ. In the present invention, the online behavior modeling mechanism 820 utilizes an auto-regression (AR) model to analyze the behavior of yₜ defined in equation 10.

If a time series residual (variable) is dictated by an auto-correlation statistical property, the AR coefficients {α₁, α₂, . . . , αₚ} can be estimated online and dynamically updated over time. Different approaches exist to perform such online estimation and dynamic updating. The identified auto-correlation may be used to predict the future residual values, hence also the variable values. This will facilitate the early warning capability of a BeX in an e-service management system by forecasting that certain threshold violation events may happen, with a certain probability, in the specified time horizon.

Prior to updating auto-correlation coefficients, the online behavior modeling mechanism 820 may detect any changes in statistical properties. This is due to the fact that the underlying time series variable (representing the residuals) are often only piecewise stochastically stationary. Therefore, the following two tasks have to be performed during online statistical learning. First, the online behavior modeling mechanism 820 identifies a new segmentation boundary whenever there is a significant statistical property change. Secondly, when the new boundary is identified, the accumulated statistics prior to the new boundary need to be flushed out so that statistical properties for the new segment can be accumulated without the data from a segment that is not statistically coherent. Such segmentation may be implemented using the Generalized Likelihood Ratio method.

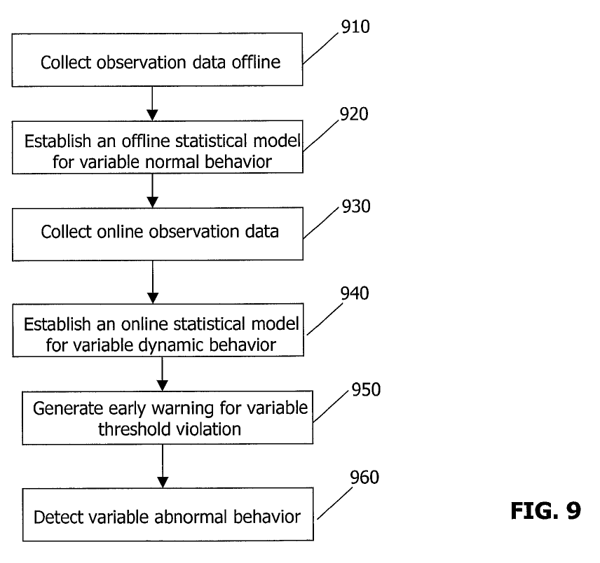

FIG. 9 is an exemplary flowchart of a process, in which statistical models characterizing the normal and dynamic behavior of a variable are established and are applied in generating early warning of threshold violation in eService management. Offline observation data with respect to a variable is first collected at act 910. The observation data collected offline is assumed to represent the normal behavior of the variable and is used to establish, at act 920, a statistical model that characterizes the normal behavior of the variable. To model the dynamic behavior of the variable, online observation data is collected at act 930 and is used to establish, at act 940, a statistical model that characterizes the dynamic behavior of the variable. The generated models are then used, at act 950, to generate early warning of threshold violation with respect to the variable. Both the established statistical models and the generated early warning are used to detect, at act 960, abnormal behavior of the variable.

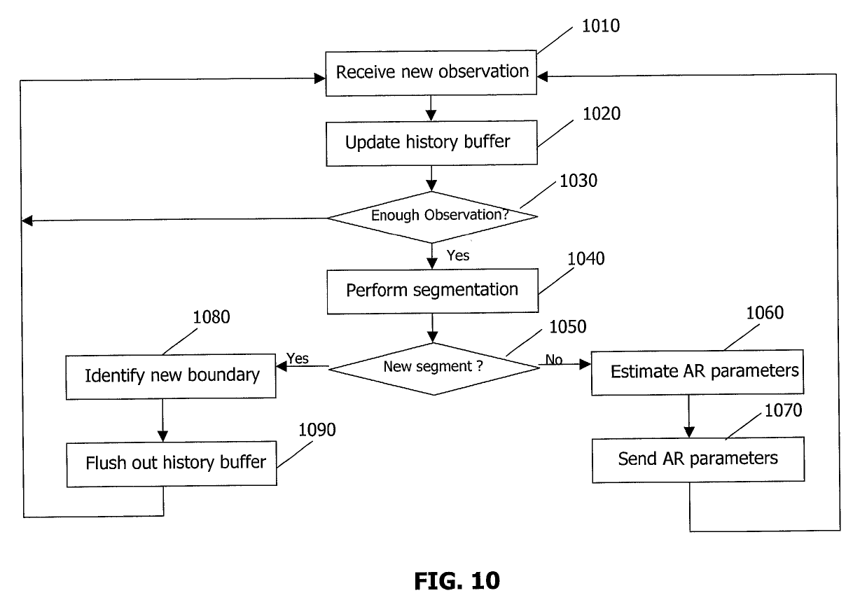

FIG. 10 is an exemplary flowchart for the online behavior modeling mechanism 820. A new observation is received first at act 1010. The received observation is used to update, at act 1020, a history buffer. The online behavior modeling mechanism 820 then examines, at act 1030, to see whether there are enough observations accumulated to perform learning. If not, the process returns back to act 1010 to collect new observations. If there are enough observations collected for learning, a segmentation is performed, at act 1040, that detects any significant statistical property change that may correspond to a different segment of data.

If a new segment is detected, determined at act 1050, the online behavior modeling mechanism 820 identifies, at act 1080, the boundary of the new segment and flushes out, at act 1090, the information that is stored in the history buffer before the detected new boundary. The process then returns to act 1010 to continue to collect new observations for the new segment. If no new segment is detected, determined at act 1050, the observation data collected so far is used to dynamically estimate (or update), at act 1060, the auto-regression parameters. Such estimated auto-regression parameters are then sent, at act 1070, to the early warning mechanism 440.

Based on the regular behavior (learned by the offline normal behavior modeling mechanism 810) and the dynamic behavior (learned dynamically by the online behavior modeling mechanism 820) of a time series variable, the future behavior of the variable may be predicted or forecasted. The certainty with which the future can be predicted may depend on many factors, including the compactness of the underlying patterns (the amount of randomness in the behavior), the depth of the historical base (how much past data is available for pattern discovery), the validity of the modeling techniques adopted, the amount of error in the model (how well the model represents the actual patterns), and how far into the future to predict (the further in the future we predict, the less confidence we have in our prediction).

The early warning mechanism 440 (FIG. 4) utilizes the predictive model created during statistical learning (by both offline normal behavior modeling mechanism 810 and the online behavior modeling mechanism 820) to evaluate the direction, magnitude, and rate of change of a BeX variable. In particular, the statistical model for the variable behavior may be used to predict when a critical threshold may be violated. To illustrate, consider a rule used in a BeX:

if X>A then

SendEvent(S1);

end if

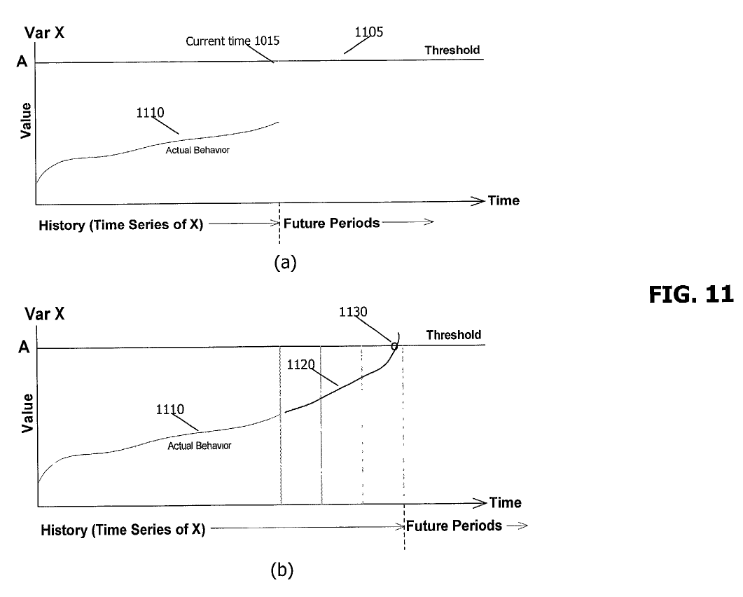

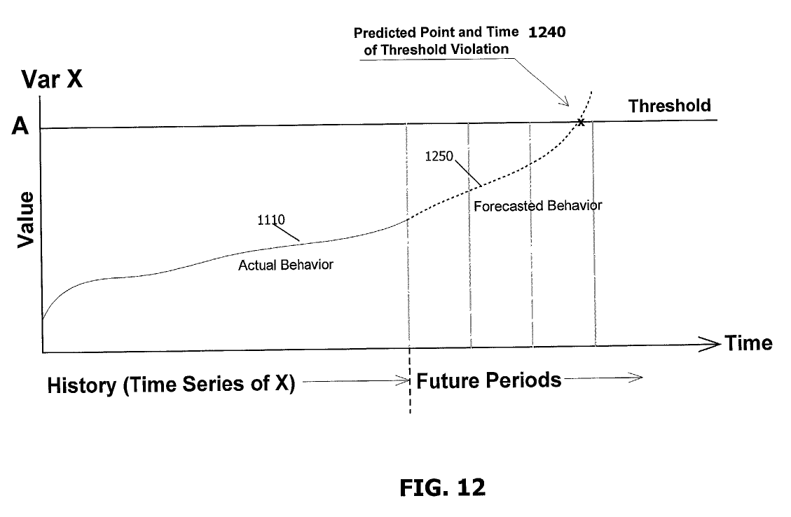

The above rule indicates “if the value of X in the current time period exceeds the threshold A, then send a violation event”. The goal of the early warning mechanism 440 is to predict when (at what of time t in the future) Xₜ will exceed the threshold A. This is illustrated in FIG. 11 and FIG. 12. In FIG. 11(a), the horizontal axis represents the time and the vertical axis represents the magnitude of a variable value. The location of the threshold A (1105) is shown in FIG. 11(a) and a curve 1110 represents the actual behavior of variable X as recorded up to the current time 1115 (the dividing point between history and future).

In FIG. 11(b), with the time, the values of variable X are continuously measured and recorded. Such recorded values form a continuing curve 1120. From curve 1120, it can be seen that the values of variable X over time (the behavior of variable X) are steadily trending toward the threshold (note that “steadily trending” is not a requirement of the model, but is used here to simplify the discussion.). In FIG. 11(b), the movement of X is recorded across the next three analysis intervals (these might correspond to the data sampling rates of the variable) and eventually at the third interval, the variable X exceeds the threshold A and an event may be thrown to indicate that an abnormal event has been detected.

The goal of the early warning mechanism 440 is to predict the likelihood of a threshold violation at a specific time in the future and may assign that likelihood a degree of certainty. The statistical model of a variable learned during offline and online statistical learning may be used to facilitate the task. This is illustrated in FIG. 12. When statistical learning is applied to the curve 1110, a statistical model can be derived that characterizes the behavior of variable X based on the data points on curve 1110. Such a statistical model allows the early warning mechanism 440 to look ahead a number of analysis periods and forecast the behavior of the variable X. In FIG. 12, the dotted curve 1250 represents the predicted behavior of variable X in the next three sampling points and a predicted point and time 1240 of threshold violation may also be estimated.

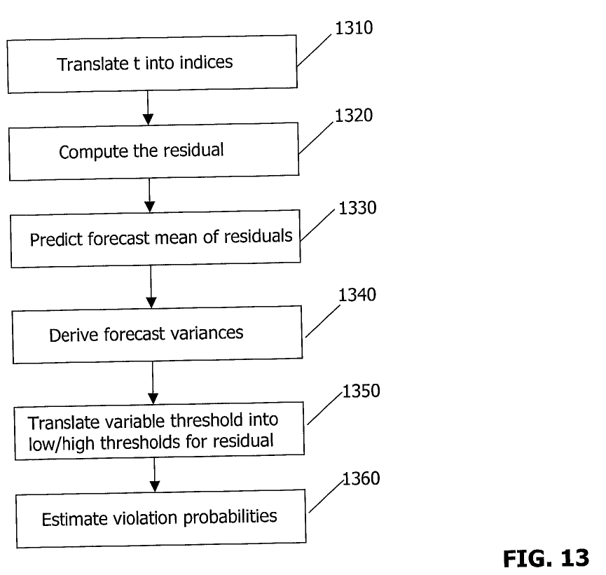

In FIG. 13, an exemplary flowchart for the early warning mechanism 440 is described. Given a time reference value t, the early warning mechanism 440 first identifies, at act 1310, the corresponding indices i, j, k (e.g., day, week, month), based on which the residual value at time t or yₜ is derived, at act 1320, based on the statistical model of the variable. That is,

yₜ=μ−αₗ−βⱼ−γₖ.

Using the current value of the residual yₜ, the early warning mechanism 440 generates, at act 1330, a forecast of the residual value at a number of future time reference points. For example, to predict the forecast mean of yₜ at the future time reference points of t+1, t+2, . . . , t+H, or t+h, h−1, 2, . . , H, where His the maximum prediction horizon, the following computation may be carried out:

yₜ₊₁=cₗyₜ+c₂yₜ₋₁

yₜ₊₂=c₁yₜ₊₁+c₂yᵢ . . .

y_{t+H}=c₁y_{t+H-1}+c₂y_{t+H-2}

where second order AR process is assumed here.

The early warning mechanism 440 then estimates, at act 1340, the variances of the generated forecasts at time h=1, 2, . . . , H:

$${σ}_{t}^{2} = {σ}_{u}^{2} [ {\sum }_{n = 0}^{h - 1} \frac{{( {A}_{1}^{n + 1} - {A}_{2}^{n + 1} )}^{2}}{{( {A}_{1} - {A}_{2} )}^{2}} ]$$

where

A₁A₂=−c₂, A₁+A₂=c₁.

In order to predict when, in the future, the variable value will exceeds some variable threshold, the early warning mechanism 440 further estimates the probability that the variable value exceeds the variable threshold at every h=1, 2, . . . , H. Alternatively, if the threshold for the variable values can be translated into corresponding residual thresholds for the residual values of the variable, the early warning mechanism 440 may also estimate the probability for the residuals to exceed the corresponding residual thresholds derived accordingly for the residuals.

Some BeXs may also employ rules enforce that variable values to be within a specific range, defined by two thresholds—a low and a high threshold. In this case, the prediction of a threshold violation may be estimated with respect to both thresholds. Similarly, the prediction of a violation with respect to both low and high variable thresholds may be performed based on residual values using translated low and high thresholds for the residual values.

In the exemplary flowchart for the early warning mechanism 440, shown in FIG. 13, a low variable threshold T and a high threshold T′ for the variable are translated, at act 1350, into the corresponding low and high residual thresholds (e.g., Th and Th′) using the following computation:

th′ₜ₊ₕ=T′−μ−α_{t′}−β_{j′}−γ_{k′}

thₜ₊ₕ=T−μ−α_{t′}−β_{j′}−γ_{k′}

where (i′, j′, k′) are the indices for t+h.

Based on derived low and high residual thresholds, the probability for a residual value to remain within the range of [th, th′] (or X within [T, T′]) can be computed, at act 1360, as:

$${P}_{t + h} = Φ ( \frac{{y}_{t + h} - {th}_{t + h}}{{σ}_{t + h}} ) + Φ ( \frac{{th}_{t + h}^{′} - {y}_{t + h}}{{σ}_{t + h}} ) , h = 1 , 2 , … , H$$

where Φ(x) is the Cumulative Distribution Function (CDF) of standard normal at x,

$$Φ ( x ) = {\int }_{- ∞}^{x} \frac{1}{\sqrt{2 π}} {ⅇ}^{- {x}^{2}}$$

The probability for the variable to exceed the threshold can be simply derived from 1−Pₜ₊ₕ.

The thresholds (T, T′) and the maximum number of future time steps H may be determined by the designer or user of the BeX. The predictive detection system will generate a forecast of the variable values in each future time interval as well as the probability of violating the thresholds. An early warning message may be sent out if the model predicts a threshold violation with a sufficiently high probability (may also be established by the designer or a user).

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A system for early warning in an e-service management system, comprising:
a statistical learning mechanism for performing statistical learning based on a plurality of data values of a variable to generate a statistical model characterizing the behavior of the variable;
an early warning mechanism for generating an early warning of threshold violation of the variable with respect to a threshold by predicting, based on the statistical model, a future time by which the values of the variable exceeds the threshold; and
an operational mechanism for detecting abnormal behavior of the variable based on both the statistical model and the early warning.

2. The system according to claim 1, wherein the statistical learning mechanism comprises:
an offline normal behavior modeling mechanism for modeling the regular behavior of the variable based on the plurality of values of the variable collected offline over a period of time; and
an online behavior modeling mechanism for modaling the dynamic behavior of the variable based on a plurality of values of the variable collected online during the operations performed by the operational mechanism.

3. A method for early warning in an e-service management system, comprising:
modeling the behavior of a variable based on a plurality of data values of the variable collected over a period of time, said modeling being performed based on the statistical properties of the data values of the variable to generate a behavior model for the variable, the behavior model being represented using a plurality of model parameters;
generating an early warning for a threshold violation of the variable with respect to a threshold based on a plurality of data values of the variable collected online and the behavior model;
detecting abnormal behavior of the variable according to the plurality of data values of the variable collected online and the early warning.

4. The method according to claim 3, wherein the modeling comprises:
establishing, by an offline normal behavior modeling mechanism, a first statistical model that characterizes the regular behavior of the variable based on a first set of values of the variable collected offline over a period of time; and
establishing a second statistical model that characterizes the dynamic behavior of the variable based on a second set of values of said variable collected online, said first and said second statistical model comprising said behavior model.

5. The method according to claim 3, wherein generating an early warning comprises:
computing a plurality of residuals at corresponding different time reference points in the future based on the model parameters;
deriving the variances of the plurality of residuals, predicted by said predicting;
estimating the probabilities for threshold violation of the variable with respect to said threshold at the corresponding different time reference points in the future; and
issuing an early warning for any of the time reference points at which the probability for threshold violation of the variable exceeds a pre-determined value.

6. The method according to claim 5, wherein the estimating the probabilities comprises:
translating the threshold for the variable to corresponding residual threshold for the residual of the variable;
calculating the probabilities for threshold violation of the residual with respect to the residual threshold at the corresponding different time reference points in the future.

7. A computer-readable medium encoded with a program for early warning in an e-service management system, the program, when executed, causing:
modeling the behavior of a variable based on a plurality of data values of the variable collected over a period of time, said modeling being performed based on the statistical properties of the data values of the variable to generate a behavior model for the variable, the behavior model being represented using a plurality of model parameters;
generating an early warning for a threshold violation of the variable with respect to a threshold based on a plurality of data values of the variable collected online and the behavior model;
detecting abnormal behavior of the variable according to the plurality of data values of the variable collected online and the early warning.

8. The medium according to claim 7, wherein the modeling comprises:
establishing, by an offline normal behavior modeling mechanism, a first statistical model that characterizes the regular behavior of the variable based on a first set of values of the variable collected offline over a period of time; and
establishing a second statistical model that characterizes the dynamic behavior of the variable based on a second set of values of said variable collected online, said first and said second statistical model comprising said behavior model.

9. The medium according to claim 7, wherein generating an early warning comprises:
computing a plurality of residuals at corresponding different time reference points in the future based on the model parameters;
deriving the variances of the plurality of residuals, predicted by said predicting;
estimating the probabilities for threshold violation of the variable with respect to said threshold at the corresponding different time reference points in the future; and
issuing an early warning for any of the time reference points at which the probability for threshold violation of the variable exceeds a pre-determined value.

10. The medium according to claim 9, wherein the estimating the probabilities comprises:
translating the threshold for the variable to corresponding residual threshold for the residual of the variable;
calculating the probabilities for threshold violation of the residual with respect to the residual threshold at the corresponding different time reference points in the future.
